(19) United States
(12) Patent Application Publication
(10) Pub. No.: US 2009/0008990 A1
(43) Pub. Date: Jan. 8, 2009

(54) Rail slides for track suspension systems

(76) Inventor: Guy Sibilleau, Roseau, MN (US)

Correspondence Address: BAKER & DANIELS LLP, 300 NORTH MERIDIAN STREET, SUITE 2700, INDIANAPOLIS, IN, 46204, US

(21) Appl. No.: 11/069,469

(22) Filed: Mar. 1, 2005

(51) Int. Cl. B62D 55/104; B62M 29/00

(52) U.S. Cl. 305/127; 180/193

(57) ABSTRACT

A rail slide for a slide rail suspension system in a vehicle having an endless track, the rail slide having a sliding surface for contacting the endless track, the sliding surface containing one or more grooves aligned at an angle with respect to a longitudinal axis of the rail slide and containing a low friction insert material therein.

### FIELD OF THE INVENTION

Certain embodiments of the invention relate to slide rail suspension systems for use in vehicles having an endless track.

### BACKGROUND OF THE INVENTION

Snowmobiles typically have a front steering ski and a track suspension system carried by a subframe rearwardly of the ski, with the subframe being resiliently suspended from the main frame of the snowmobile. The track suspension system of a snowmobile is important because it determines, at least to some extent, the vehicle's shock-absorbing capability, stability, handling, traction, and power requirements.

A common type of track suspension system used in snowmobiles is the slide rail suspension system, in which the lower run of the drive track travels in sliding engagement with a pair of longitudinally extending rail beams. Rail slides, slide rails, slide bars, sliders or wear blades as they may be variously called, are a key component of the suspension system, having a sliding surface and bearing all or most of the weight of the sled upon the inside surface of the track. There are typically two parallel rail slides running lengthwise within the track; one on each side of the sled. The track rotates around the suspension system and slides under the rail slides as it contacts the ground surface. Snow, ice, water and other fluids can act as a lubricant between the track and rail slides to reduce friction. The advantage of a slide rail suspension over bogie wheel suspension systems and other systems is that the slide rail system tends to hold the track flatter against the ground or snow in rough or variable terrain, which can be important when speed or power is required, such as in racing.

One drawback commonly seen with slide rail suspension systems is that heat and mechanical stresses between the track and rail slide often decrease efficiency, e.g., by increasing friction, limiting speeds and quickly deteriorating or destroying the contact surface and/or mechanical integrity of the rail slide. Snowmobiles over the years have also become heavier, faster and more powerful and rail slides are subject to even greater mechanical and heat stresses than in the past years. In addition, these stresses are magnified when snowmobiles are operated under adverse conditions, such as, on surfaces where there is no snow or water to cool and lubricate the interface between the rail slide and the endless track, or on surfaces which cause debris such as dirt, sand, and gravel to contaminate the interface between the rail slide and the endless track.

In view of the foregoing, there is a need for an improved slide rail suspension system for snowmobiles and other tracked vehicles which will eliminate or alleviate the foregoing disadvantages of existing systems. There is particularly a need for an improved slide rail suspension system in which there is increased efficiency between the rail slides and the endless track.

### BRIEF SUMMARY OF THE INVENTION

Certain embodiments of the invention provide a rail slide for a slide rail suspension system in a vehicle having an endless track. The rail slide has a sliding surface for contacting the endless track. In some cases, the sliding surface contains one or more grooves aligned at an angle, e.g., in one embodiment at or less than about 90 degrees and in another embodiment at or less than about 30 degrees, with respect to the rail slide. The one or more grooves contain a low friction insert material, e.g., a polyimide material that may be molded into the grooves. The grooves may also be positioned along the rail slide at equal intervals. The grooves can extend entirely across the width of the sliding surface or substantially across the width of the sliding surface. In other cases, the sliding surface has discrete areas of low friction material, e.g., discrete areas of a polyamide material. The discrete areas can have any suitable shape and may be aligned at angles with respect to the longitudinal axis of the rail slide, e.g., in certain embodiments at or less than about 90 degrees and in other embodiments at or less than about 30 degrees.

Certain embodiments of the invention provide provides a track assembly for a vehicle, comprising an endless track and a slide rail suspension system, the slide rail suspension system comprising at least one rail slide having a sliding surface for contacting the endless track, the sliding surface having one or more grooves aligned at an angle with respect to the rail slide and containing a low friction insert material therein.

Certain embodiments of the invention provide a tracked vehicle, e.g., a snowmobile, having a slide rail suspension system including at least one rail slide having a sliding surface for contacting the endless track. In some cases, the sliding surface contains one or more grooves aligned at an angle with respect to the rail slide. The grooves contain a low friction insert material therein. In other cases, the sliding surfaces contains discrete areas of low friction material.

Certain embodiments of the invention provide provides a snowmobile having a chassis, an engine disposed on the chassis, at least one ski disposed on the chassis, a steering column operatively connected to the at least one ski for steering the snowmobile, an endless track disposed below the chassis and being operatively connected to the engine, and a slide rail suspension system having at least one rail slide having a sliding surface for contacting the endless track, the sliding surface containing one or more grooves aligned at an angle with respect to the rail slide and containing a low friction insert material therein.

### BRIEF DESCRIPTION OF THE DRAWINGS

FIG. 1 is a bottom view of a sliding surface of a rail slide showing a sliding surface having plurality of grooves;

FIG. 2 is a bottom view of the sliding surface of FIG. 1 further showing inserts within the plurality of grooves;

FIG. 3 is a perspective view of the rail slide;

FIG. 4 is a cross-sectional view of the rail slide showing a groove configured according to one embodiment;

FIG. 5 is a cross-sectional view of the rail slide of FIG. 4 showing an insert positioned within the groove;

FIG. 6 is a cross-sectional view of the rail slide showing a groove configured according to another embodiment;

FIG. 7 is a cross-sectional view of the rail slide of FIG. 6 showing an insert positioned within the groove;

FIG. 8 is a bottom view of a second sliding surface of a rail slide showing a sliding surface having plurality of grooves;

FIG. 9 is a bottom view of the second sliding surface of FIG. 8 further showing inserts within the plurality of grooves;

FIG. 10 is a perspective view of the second rail slide;

FIG. 11 is a cross-sectional view of a second rail slide showing a groove configured according to one embodiment;

FIG. 12 is a cross-sectional view of the rail slide of FIG. 11 showing an insert positioned within the groove;

FIG. 13 is a cross-sectional view of a second rail slide showing a groove configured according to another embodiment;

FIG. 14 is a cross-sectional view of the rail slide of FIG. 13 showing an insert positioned within the groove;

FIG. 15 is a view of a vehicle track assembly incorporating a second rail slide; and

FIG. 16 is a view of a snowmobile having a slide rail suspension system incorporating a second rail slide.

### DETAILED DESCRIPTION OF THE INVENTION

Embodiments of the invention are disclosed. One skilled in the art will appreciate that the present invention can be practiced with embodiments other than those disclosed. The disclosed embodiments are presented for purposes of illustration and not limitation, and the present invention is limited only by the claims that follow.

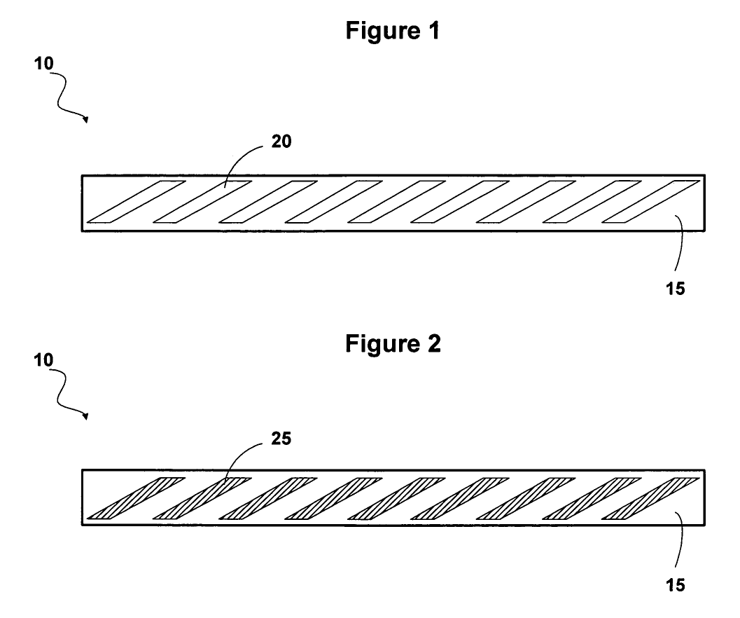

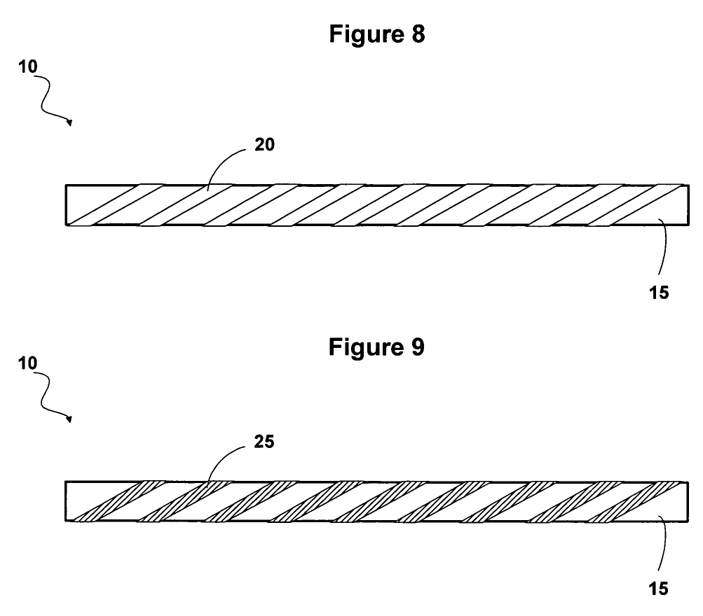

With reference to FIG. 1 and FIG. 8, certain embodiments of the invention provides a rail slide 10 having a longitudinal axis and a sliding surface 15 for slidingly engaging an endless track of a tracked vehicle. The sliding surface 15 contains a plurality of grooves 20 adapted for receiving inserts 25. The sliding surface 15 can be comprised of a synthetic resin, including synthetic plastics such as polytetrafluoroethylene (PTFE), nylon, polyurethane and ultra high density polyethylene. In some cases, the entire rail slide 10 is made of the same material whereas in other cases, the sliding surface 15 is made of one material whereas the remaining rail slide 10 is made of another material. Additionally, the sliding surface 15 can be made of a material more expensive than the material comprising the rail slide 10, or vice-versa.

The grooves 20 may be obliquely aligned in relation to the rail slide 10. In certain embodiments, the grooves 20 are spaced apart at generally equal intervals. However, the grooves 20 can be positioned at random intervals as well. The grooves 20 may also all be obliquely aligned in a common direction. However, the grooves 20 can be aligned in different directions as well. The grooves 20 can be of any shape. In the FIGS., the grooves 20 are rectangular shaped. However, the grooves 20 can also be shaped as any other suitable formation. In some cases, the grooves have a shape selected from the group consisting of rectangles, ovals, circles, diamonds, triangles and squares.

FIG. 2 illustrates the rail slide of FIG. 1 wherein a plurality of inserts 25 are positioned within the grooves 20. Likewise, FIG. 9 illustrates the rail slide of FIG. 8 showing a plurality of inserts 25 positioned within the grooves 20. The inserts 25 are generally configured in the same shape as the corresponding grooves, although this is not required. The inserts reduce the friction of the sliding surface 15 with the endless track. The inserts 25 are comprised of a low-friction material and reduce the friction of the sliding surface 15 with the endless track. In certain embodiments, the inserts 25 have a coefficient of friction of less than about 0.25 and, in other embodiments, between about 0.25 and 0.10. Likewise, the inserts 25 may have a wear factor of less than about 50×10⁻¹⁰ in³-min/ft-lb-hr. In some embodiments, the inserts 25 are made of a polyimide material. Suitable polyimide materials can be obtained from Dupont, LLC under the tradename Vespel. For example, the Vespel SP-21 polyimide resin is a particularly suitable material. In other embodiments, the inserts 25 are made of a polyamide material. Suitable polyamide materials can also be obtained from DSM Engineering Plastics under the tradename Stanyl.

The rail slide may be mounted or suspended from a slide rail suspension system in any desired manner to support the track in any desired fashion. The rail slide may be mounted to be aligned substantially longitudinally in relation to the track. In some embodiments, a side 30 of the rail slide opposite to the sliding surface 15 is configured to be received by a slide rail suspension system. In the Figures, the rail slide 10 has a bottom portion configured as a T-Slot and is adapted to be received by an I-Beam (not shown) on the rail beam of a slide rail suspension system. However, the rail slide 10 can be configured in any other suitable form to be attached to the suspension system.

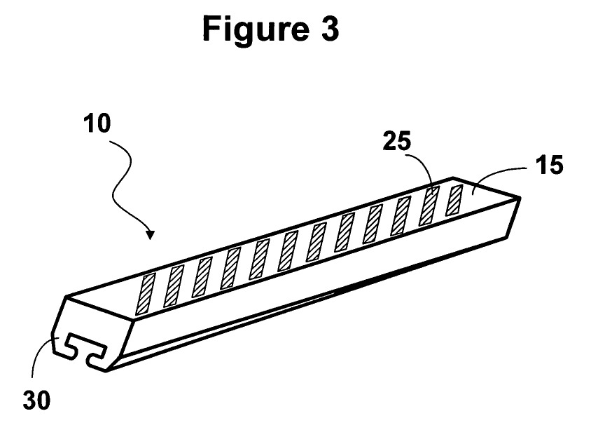

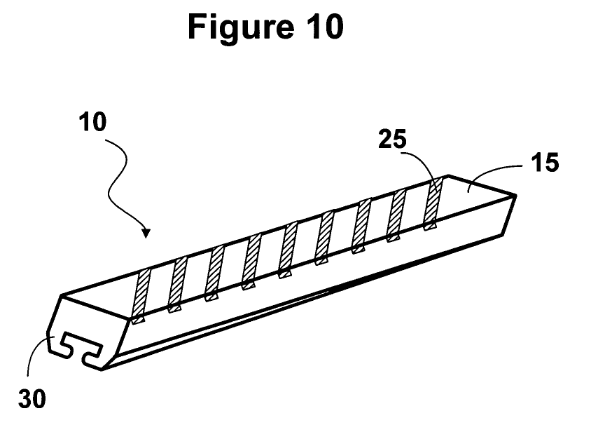

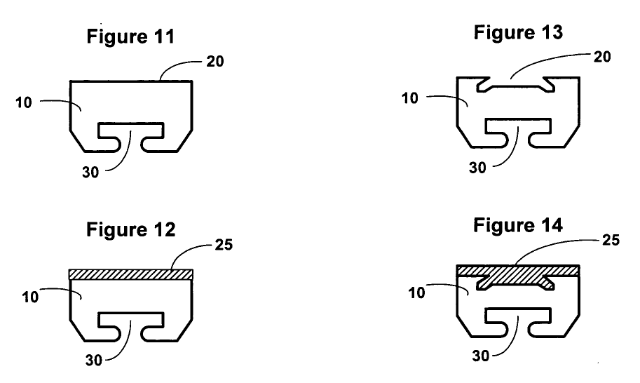

The grooves 20 on sliding surface 15 can extend entirely across the width of the sliding surface 15 or they can extend across a portion of the sliding surface. FIGS. 1-7 illustrate an embodiment wherein the grooves 20 extend across only a portion of the sliding surface and FIGS. 8-14 illustrate an embodiment wherein the grooves 20 extend entirely across the width of the sliding surface. When an insert is positioned in a groove that extends across the entire sliding surface 15, the insert is visible on all sides of the rail slide except the side 30 opposite the sliding surface 15, as best illustrated in FIG. 10. When an insert is positioned in a groove that does not extend entirely across the entire sliding surface, the groove is visible on the sliding surface 15 only, as best illustrated in FIG. 3.

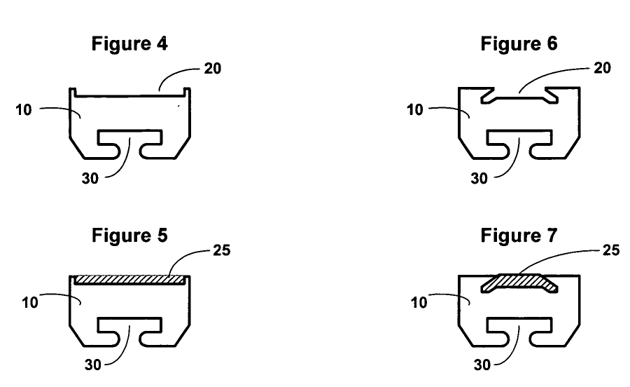

As shown in FIG. 4 and FIG. 6, the groove 20 may extend substantially across the width of the sliding surface 15, but not all the way across. As shown in FIG. 5 and FIG. 7, the insert 25 positioned within the groove 20 so that the insert 25 is only visible on the sliding surface This configuration is particularly beneficial when it is desired to mold the insert 25 into the grooves 20.

The insert 25 can be held in place within the groove according to any suitable manner. For example, in some cases, the insert is fixed within the groove 20 using a bolt or other suitable mechanical fastener. In other cases, the insert is fixed within the groove 20 using an adhesive, e.g., a glue material or other suitable chemical fastener. In certain embodiments, the insert 25 is molded into the groove 20 so that a rail slide as in FIG. 5, FIG. 7 or FIG. 14 is obtained. In FIG. 5, FIG. 7 and FIG. 14 there are no bolts or external fasteners on the outer surface of the insert 25, which enhances the low-friction properties of the insert 25.

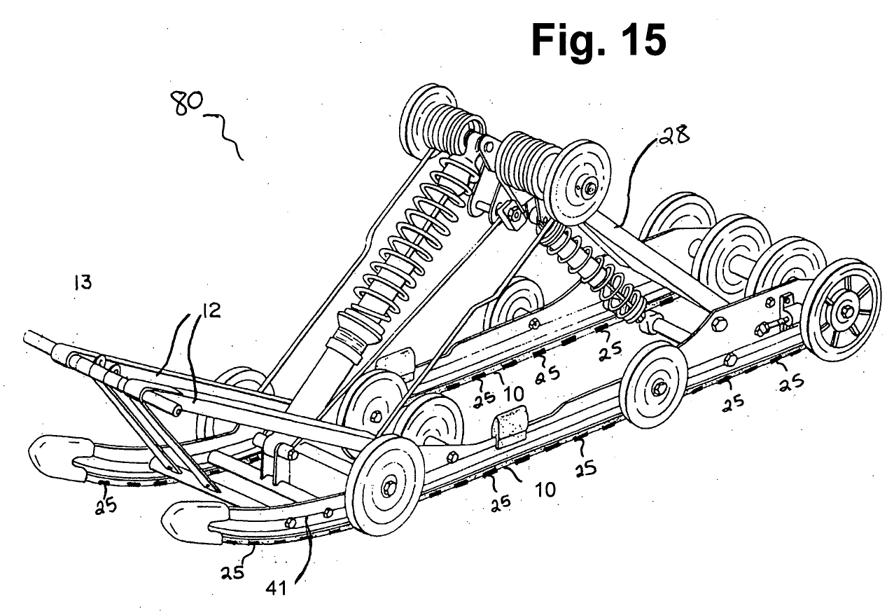

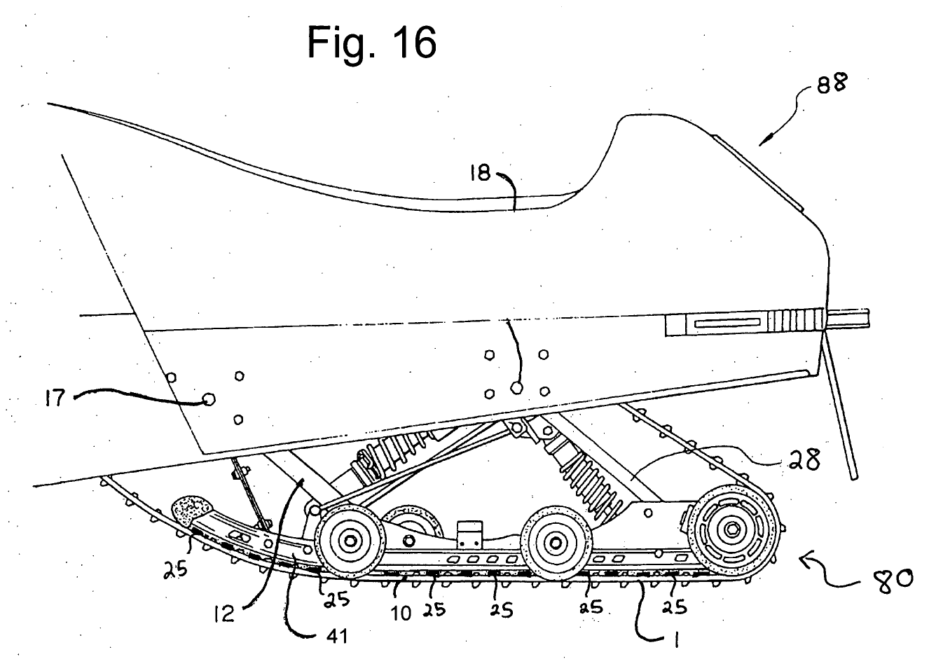

A rail slide of the invention can be used with a variety of slide rail suspension systems. The rail slide will now be described in use with the particular suspension system 80 illustrated in FIG. 15. The suspension system 80 includes a front suspension arm 12 and a rear suspension arm 28, each such arm extending downwardly and rearwardly from pivotal connections to a chassis of a vehicle. The lower end of each arm is secured, either directly or indirectly to the rail beams 41. While in the illustrated FIG. 15 and FIG. 16, two suspension arms are shown, it should be understood that any number of suspension arms can be used to connect a vehicle directly or indirectly to the rail beams. The rail slides 10 are attached to the rail beams 41 and have a plurality of inserts 25 positioned within the sliding surface 15. The inserts 25 in the rail slides of FIGS. 15 and 16 are positioned within grooves that extend entirely across the width of the sliding surface 15. As a result, the inserts 25 are viewable from the sides of the rail slides, rather than only viewable from the sliding surface 15.

The slide rail suspension system of the present will now be described in connection with a snowmobile. FIG. 16 illustrates a snowmobile 88 having the slide rail suspension system 80 of FIG. 15. As shown, the snowmobile suspension system includes a pair of rail slides 10 having a plurality of inserts incorporated in the sliding surface 15 which presses against an endless track 16 to transfer the weight of the snowmobile 88 and the endless track 16 to the ground surface. The rail slides 10 may be curved at a forward end to follow the endless track. In the illustrated embodiment, front and rear suspension arms 12 and 28 extend downwardly and rearwardly from the pivotal connections (17 and 18, respectively) to the snowmobile chassis. The lower ends of the arms link the rail beam 41 and the chassis of the snowmobile 88 together. However, it should be understood that the snowmobile chassis can contain a single suspension arm or any number of suspension arms.

The above specification provides a complete description of the manufacture and use of the embodiments of the invention. Since many embodiments of the invention can be made without deporting from the spirit and scope of the invention the invention resides in the claims hereinafter appended.

1. A rail slide for a slide rail suspension system in a vehicle having an endless track, the rail slide having a longitudinal axis and a sliding surface for contacting the endless track, the sliding surface being formed to include one or more grooves aligned at an angle with respect to the longitudinal axis of the rail slide and a durable low friction insert material coupled to the rail slide and located in the one or more grooves.

2. The rail slide of claim 1, wherein the one or more grooves are aligned at or less than about 90 degree angles with respect to the longitudinal axis of the rail slide.

3. The rail slide of claim 1, wherein the one or more grooves are aligned at approximately 30 degree angles with respect to the longitudinal axis of the rail slide.

4. The rail slide of claim 1, wherein the low friction insert material has a coefficient of friction of less than about .25.

5. The rail slide of claim 1, wherein the low friction insert material has a coefficient of friction of between about .25 and about .10.

6. The rail slide of claim 1, wherein the low friction insert material has a wear factor of less than about 50 ×10^{-10·3}-min/ft-lb-hr.

7. The rail slide of claim 1, wherein the one or more grooves are positioned along the rail slide at equal intervals.

8. The rail slide of claim 1, wherein the low friction insert material is a polyimide material.

9. The rail slide of claim 1, wherein the low friction insert material is molded within the one or more grooves.

10. The rail slide of claim 1, wherein the one or more grooves extend partially across a width of the sliding surface so that opposite ends of the one or more grooves are spaced inwardly from sides of the rail slide.

11. The rail slide of claim 1, wherein the one or more grooves extend entirely across a width of the sliding surface.

12. The rail slide of claim 1, wherein the one or more grooves have a shape selected from the group consisting of rectangles, ovals, circles, diamonds, triangles and squares.

13. A slide rail suspension system having at least one rail slide as in claim 1.

14. A tracked vehicle having a slide rail suspension system having at least one rail slide as in claim 1.

15. A snowmobile having a slide rail suspension system having at least one rail slide as in claim 1.

16. A rail slide for a slide rail system in a vehicle having an endless track, the rail slide having a sliding surface for contacting the endless track, the sliding surface having a plurality of discrete areas of durable low friction material coupled thereto.

17. The rail slide of claim 16, wherein the discrete areas of low friction material comprise discrete areas of polyamide material.

18. The rail slide of claim 16, wherein the discrete areas of low friction material have rectangular shapes.

19. The rail slide of claim 18, wherein the rectangular shapes are aligned at angles with respect to the rail slide.

20. The rail slide of claim 19, wherein the rectangular shapes are aligned at approximately 30 degree angles with respect to a longitudinal axis of the rail slide.

21. A slide rail suspension system having at least one rail slide as in claim 16.

22. A tracked vehicle having a slide rail suspension system having at least one rail slide as in claim 16.

23. A snowmobile having a slide rail suspension system having at least one rail slide as in claim 16.

24. A track assembly for a vehicle, comprising an endless track and a slide rail suspension system, the slide rail suspension system comprising at least one rail slide having a sliding surface for contacting the endless track, the sliding surface being formed to include one or more grooves aligned at an angle with respect to a longitudinal axis of the rail slide and a durable low friction insert material coupled to the rail slide and located in the one or more grooves.

25. A snowmobile comprising:
a chassis;
an engine disposed on the chassis;
at least one ski disposed on the chassis;
a steering column operatively connected to the at least one ski for steering the snowmobile;
an endless track disposed below the chassis and being operatively connected to the engine;
a slide rail suspension system having at least one rail slide having a sliding surface for contacting the endless track, the sliding surface being formed to include one or more grooves aligned at an angle with respect to a longitudinal axis of the rail slide and containing a durable low friction insert material located in the one or more grooves.

26. The rail slide of claim 1, wherein the low friction insert material is a polyamide material.

27. The rail slide of claim 1, wherein the low friction insert material is molded to the rail slide.
